(19) United States
(12) Patent Application Publication
(10) Pub. No.: US 2019/0062164 A1
(43) Pub. Date: Feb. 28, 2019

(54) PREPARATION OF CARBON NANOTUBE BASED CORE-SHELL MATERIALS

(71) Applicant: SABIC Global Technologies B.V., Bergen op Zoom (NL)

(72) Inventors: Ihab N. ODEH, Sugar Land, TX (US); Yunyang LIU, Thuwal (SA)

(73) Assignee: SABIC Global Technologies B.V., Bergen op Zoom (NL)

(21) Appl. No.: 15/770,552

(22) PCT Filed: Sep. 30, 2016
(86) PCT No.: PCT/US2016/054792

§ 371 Date: Apr. 24, 2018

Related U.S. Application Data
(60) Provisional application No. 62/246,356, filed on Oct. 26, 2015.

(51) Int. Cl. C01B 32/168; B01J 13/02; H01M 4/583; H01M 4/96; B01J 21/18; B01J 35/00; B01J 37/08; B01J 37/06; H01G 11/36; H01G 11/24; H01G 11/86

(52) U.S. Cl. CPC C01B 32/168; B01J 13/02; H01M 4/583; H01M 4/96; B01J 21/185; B82Y 30/00; B01J 37/084; B01J 37/06; H01G 11/36; H01G 11/24; H01G 11/86; B01J 35/0013

(57) ABSTRACT

A carbon nanotube material, methods of making and uses thereof are described. The carbon nanotube material can include a shell having a network of carbon nanotubes and a plurality of discrete void spaces contained within and surrounded by the network. The boundary of each void space is defined by the carbon nanotube network.

### CROSS REFERENCE TO RELATED APPLICATIONS

This application claims benefit to U.S. Provisional Patent Application No. 62/246,356, filed Oct. 26, 2015, which is incorporated herein in its entirety.

### BACKGROUND OF THE INVENTION

### A. Field of the Invention

The invention generally concerns a carbon nanotube material and uses thereof. The carbon nanotube material includes a shell that has a network of carbon nanotubes and a plurality of discrete void spaces contained within and surrounded by the carbon nanotube network. The boundary of each void space is defined by the carbon nanotube network.

### B. Description of Related Art

Carbon nanotubes (CNTs) are nanometer-scale tubular-shaped graphene structures that have extraordinary mechanical, chemical, optical and electrical properties (See, Iijima, “Helical microtubules of graphitic carbon”, Nature, 1991, 354, 56-58. By way of example, CNTs have been shown to exhibit good electrical conductivity and tensile strength, including high strain to failure and relatively high tensile modulus. CNTs have also been shown to be highly resistant to fatigue, radiation damage, and heat. These properties make CNTs a material that can be used in a variety of applications (e.g., conductive, electromagnetic, microwave, absorbing, high-strength composites, super capacitor, battery electrodes, catalyst and catalyst supports, field emission displays, transparent conducting films, drug delivery systems, electronic devices, sensors and actuators).

Several different processes for making CNTs have been developed over the years. Generally, the three main methods are: (1) arc discharge method (See, Iijima, “Helical Microtubules of Graphitic Carbon”, Nature, 1991, 354:56-58, “Iijima”); (2) laser ablation method (See, Ebbesen et al., “Large-scale Synthesis of Carbon Nanotubes”, Nature, Vol. 1992, 358:220); and (3) chemical vapor deposition (CVD) method (See, Li et al., “Large-scale Synthesis of Aligned Carbon Nanotubes”, Science, 1996, 274:1701). Other CNT production methods have also been developed. For instance, Zhang et al., “Spherical Structures Composed of Multiwalled Carbon Nanotubes: Formation Mechanism and Catalytic Performance” Angew. Chem. Int. ed., 2012, 51, 7581-7585, discloses a process to produce a solid CNT monolith as an alternative to the more typical chemical-vapor-deposition (CVD) process and indicates that its process would allow for large scale production of CNTs.

Despite all of the currently available research on CNTs, utilization of their unique properties has yet to be fully realized. This is due, in part, to the structural limitations currently seen with CNT-based materials. In particular, while the above CNT production processes can be used to produce CNTs, these processes are limited and typically do not allow for the preparation of CNTs having desired structural properties. By way of example, one of the common uses of CNTs are as a solid support such as that shown in Xia et al. “Pd-induced Pt(IV) reduction to form Pd@Pt/CNT core@shell catalyst for a more complete oxygen reduction” J. Material Chemistry A, 2013, 1, 14443. Xia et al. describes the use a functionalized solid carbon nanotube support for growing Pd@Pt core/shell particles on the surface of said CNT support. In particular, electrons from the solid CNT support were used to reduce Pt⁴⁺ ions and form the Pt shell around the Pd core. The resulting CNT supported Pd@Pt metal catalyst is said to be useable in the O₂ reduction reaction.

### SUMMARY OF THE INVENTION

A discovery has been made that offers a solution to some of the structural limitations currently associated with CNT-based materials. The solution is premised on introducing a plurality of discrete void spaces in a carbon nanotube network. In particular, a CNT material has been discovered that includes a shell having a network of carbon nanotubes and a plurality of void spaces contained within and surrounded by the network, wherein the boundary of each void space is defined by the carbon nanotube network. The shell can consist essentially of or consist of CNTs. The void spaces can be structured such that they are empty, thereby creating a structure having a honeycomb-like or multi-void morphology or structure. Alternatively, the void spaces can be designed or tuned such that nanostructures are included in each void space. The nanostructures can be selected for a desired result (e.g., catalytic metals can be included in the void spaces to catalyze a given chemical reaction such as hydrocarbon cracking reactions, hydrogenation of hydrocarbon reactions, and/or a dehydrogenation of hydrocarbon reactions). When nanostructures are present in the void spaces, at least two additional types of overall structures can be obtained: (1) a pomegranate-like multi-core/shell structure, or (2) a pomegranate-like multi-yolk/shell structure. In either instance, increased loading of nanostructures (e.g., nanoparticles) can be obtained via loading of each void space. Further, a reduction or prevention of nanostructures sintering can also be obtained due to the void spaces acting like separate cages for each of the nanomaterials, thereby preventing each nanostructure from contacting and sintering with one another. Still further, the carbon nanotube network has good flow flux properties due to the network itself and/or the hollow nature of the carbon nanotubes (i.e., the hollow channels present in carbon nanotubes). The network and/or carbon nanotube channels provide access to each of the void spaces, thereby allowing chemicals to both enter and exit the void spaces via the CNT network and/or nanotube channels (e.g., chemicals can (1) contact the outer surface of the CNT material of the present invention and enter the void space via a CNT channel or (2) exit the void space and ultimately exit the CNT material via a CNT channel).

In addition, the processes used to make the CNT materials of the present invention allow for the introduction of a wide range of structural modifications or tunability to the materials. By way of example, the overall size and/or shape of the CNT material can be designed as needed (e.g., spherical, square, pyramid, and the like). Even further, the volume and/or shape of the discrete void spaces can also be tuned as desired, with a spherical shape being preferred in some instances. Still further, other tunable options that can be implemented include the number of void spaces present in the CNT materials of the present invention, the thickness of the CNT network shell, the types of nanostructures included in the void spaces, the introduction of nanostructures into the CNT network itself, surface loading of the CNT materials, etc. Stated plainly, the processes of making the CNT materials of the present invention can be tuned to introduce a number of desired structural features in the resulting CNT materials.

In one aspect of the present invention, a carbon nanotube material is described. The carbon nanotube material includes a shell. The shell can include a network of carbon nanotubes (e.g., single and/or multi-walled) having a plurality of discrete void spaces (e.g., 2 to 10,000 void spaces) contained within and surrounded by the carbon nanotube network. The boundary of each void space can be defined by the carbon nanotube network. An average volume of each void space can range from 1 nm³ to 10⁶ μm³. The carbon nanotube material can be a substantially spherical particle having a diameter of 1 nm to 100,000 nm (100 μm). A diffusion transport (flow flux or permeability) of the shell can range from 1×10⁻⁶ to 1×10⁻⁴ mol m⁻²s⁻¹ Pa⁻¹. A polymer, a metal particle, a metal oxide particle, a silicon particle, a carbon-based particle, a metal organic framework particle, a zeolitic organic framework particle, a covalent organic framework particle, or any combination thereof can be included in carbon nanotube network and/or the void spaces within the network. However, in a particular embodiment, the carbon nanotube network shell consists essentially of or consists of carbon nanotubes. In some embodiments, the shell is a monolith network of carbon nanotubes. In some aspects, the void space can include a nanostructure core (e.g., core@shell type structure). In other aspects, the void space can include a nanostructure. The nanostructure can have a diameter of 1 nm to 1000 nm, preferably 1 nm to 50 nm, or more preferably 1 nm to 5 nm. In some aspects, each nanostructure can fill the entire volume of each void space (e.g., core@shell type structure). In other aspects, the nanostructure can fill 1% to 99%, preferably 30% to 60%, of the volume of each void space (e.g., yolk@shell type structures). The nanostructure can be a metal nanoparticle, a metal oxide nanoparticle, a silicon particle, a carbon-based nanoparticle, a metal organic framework nanoparticle, a zeolitic imidazolated framework nanoparticle, a covalent organic framework nanoparticle, or any combination thereof. A metal nanoparticle can include a noble metal (e.g. silver (Ag), palladium (Pd), platinum (Pt), gold (Au), rhodium (Rh), ruthenium (Ru), rhenium (Re), or iridium (Ir), or any combinations or alloys thereof), a transition metal (e.g., copper (Cu), iron (Fe), nickel (Ni), zinc (Zn), manganese (Mn), chromium (Cr), molybdenum (Mo), tungsten (W), osmium (Os), or tin (Sn), or any combinations or oxides or alloys thereof), or both. Non-limiting examples of metal oxide nanoparticle include silica (SiO₂), alumina (Al₂O₃), titania (TiO₂), zirconia (ZrO₂), germania (GeO₂), stannic oxide (SnO₂), gallium oxide (Ga₂O₃), zinc oxide (ZnO), hafnia (HfO₂), yttria (Y₂O₃), lanthana (La₂O₃), ceria (CeO₂), or any combinations or alloys thereof. The carbon-based nanoparticle can include carbon nanotubes.

Methods of making a carbon nanotube material (e.g., a multi-core/carbon nanotube shell material, a multi-yolk/carbon nanotube shell material, or a multi-void/carbon nanotube shell material) are disclosed. In one embodiment, a method can include (a) obtaining a composition that includes a plurality of nanostructures dispersed throughout a carbon-containing polymeric matrix, and (b) subjecting the carbon-containing polymeric matrix to a graphitization process to form a shell having a carbon nanotube network from the matrix. From this method a multi-core/carbon nanotube shell material is obtained that includes a shell having a network of carbon nanotubes and a plurality of discrete nanostructure cores contained within and surrounded by the network. The polymeric matrix can include any polymer having ion exchange capabilities. Such a polymeric matrix can be used as a carbon source for formation of the carbon nanotubes. The polymeric matrix can be cross-linked with a cross-linking agent (e.g., divinylbenzene). To obtain the composition in step (a) nanostructures previously described can be dispersed in a solution that includes a carbon-containing compound, and optionally, a cross-linking agent. This solution can then be polymerized to form the composition of step (a). The graphitization process can include heating the composition to a temperature of 400° C. to 1000° C. under an inert atmosphere. In some embodiments, the nanostructures can catalyze the growth of the carbon nanotubes during the graphitization of the polymeric matrix. In one aspect, a metal catalyst is loaded onto the matrix prior to or during the step (b) graphitization process to catalyze the growth of CNTs during the graphitization of the polymeric matrix. The resulting multi-nanostructure carbon nanotube material can be subjected to an etching process to obtain a multi-void/carbon nanotube shell structure or multi-yolk/carbon nanotube shell structure. The etching process partially or fully removes the plurality of nanostructures such that a plurality of discrete void spaces is obtained and the boundary of each void space is defined by the carbon nanotube network. In some aspects, the plurality of nanostructure cores are partially etched such that each nanostructure fills 1% to 99%, preferably 30% to 60%, of the volume of each void space. When the nanostructure is fully etched away, no nanostructure is left in the void space. Such a method can also produce the previously described carbon nanotube material having multiple void spaces.

Methods for using the previously described carbon nanotube material are described. One method can include contacting the catalyst with a reactant feed to catalyze the reaction and produce a product feed. The chemical reaction can include a hydrocarbon hydroforming reaction, a hydrocarbon cracking reaction, a hydrogenation of hydrocarbon reaction, and/or a dehydrogenation of hydrocarbon reaction or any combination thereof. In some embodiments, the carbon nanotube material can be used in automotive 3-way catalysis (e.g., catalytic converters), diesel oxidation catalysis, environmental remediation catalysis, energy storage applications (e.g., fuel cells, batteries, supercapacitors, and electrochemical capacitors), optical applications, and/or controlled release applications. In one particular instance, the carbon nanotube material of the present invention can be incorporated into a secondary or rechargeable battery. For example, it could be used in the cathode of the secondary battery. The secondary battery can be a lithium-ion or lithium-sulfur battery.

In yet another aspect, a system for producing a chemical product is disclosed. The system can include (a) an inlet for a reactant feed, (b) a reaction zone that is configured to be in fluid communication with the inlet, and (c) an outlet configured to be in fluid communication with the reaction zone and configured to remove a product stream from the reaction zone. The reaction zone can include the carbon nanotube material of the present invention; The reaction zone can be a continuous flow reactor (e.g., a fixed-bed reactor, a fluidized reactor, a moving bed reactor, etc.).

Also disclosed in the context of the present invention are embodiments 1-48. Embodiment 1 is a carbon nanotube material comprising a shell having a network of carbon nanotubes and a plurality of discrete void spaces contained within and surrounded by the network, wherein the boundary of each void space is defined by the carbon nanotube network. Embodiment 2 is the carbon nanotube material of embodiment 1, wherein the average volume of each discrete void space is 1 nm³ to 10⁶ μm³. Embodiment 3 is the carbon nanotube material of any one of embodiments 1 to 2, wherein the shell consists essentially of or consists of carbon nanotubes. Embodiment 4 is the carbon nanotube material of any one of embodiments 1 to 3, comprising 2 to 10,000 void spaces. Embodiment 5 is the carbon nanotube material of any one of embodiments 1 to 4, wherein the shell has a flow flux of 1×10⁻⁶ to 1×10⁻⁴ mol m⁻² s⁻¹ Pa. Embodiment 6 is the carbon nanotube material of any one of embodiments 1 to 5, wherein each void space comprises a nanostructure. Embodiment 7 is the carbon nanotube material of embodiment 6, wherein the nanostructure comprises a metal nanoparticle, a metal oxide nanoparticle, a silicon particle, a carbon-based nanoparticle, a metal organic framework nanoparticle, a zeolitic imidazolated framework nanoparticle, a covalent organic framework nanoparticle, or any combination thereof. Embodiment 8 is the carbon nanotube material of embodiment 7, wherein the metal nanoparticle is a noble metal selected from the group consisting of silver (Ag), palladium (Pd), platinum (Pt), gold (Au), rhodium (Rh), ruthenium (Ru), rhenium (Re), or iridium (Ir), or any combinations or alloys thereof. Embodiment 9 is the carbon nanotube material of embodiment 7, wherein the metal nanoparticle is a transition metal selected from the group consisting of copper (Cu), iron (Fe), nickel (Ni), zinc (Zn), manganese (Mn), chromium (Cr), molybdenum (Mo), tungsten (W), osmium (Os), or tin (Sn), or any combinations or oxides or alloys thereof. Embodiment 10 is the carbon nanotube material of embodiment 7, wherein the metal oxide nanoparticle is a metal oxide selected from silica (SiO₂), alumina (Al₂O₃), titania (TiO₂), zirconia (ZrO₂), germania (GeO₂), stannic oxide (SnO₂), gallium oxide (Ga₂O₃), zinc oxide (ZnO), hafnia (HfO₂), yttria (Y₂O₃), lanthana (La₂O₃), ceria (CeO₂), or any combinations or alloys thereof. Embodiment 11 is the carbon nanotube material of embodiment 7, wherein the carbon-based nanoparticle comprises carbon nanotubes.

Embodiment 12 is the carbon nanotube material of any one of embodiments 6 to 11, wherein each nanostructure has a diameter of 1 nm to 1000 nm, preferably 1 nm to 50 nm, or more preferably 1 nm to 5 nm. Embodiment 13 is the carbon nanotube material of any one of embodiments 6 to 12, wherein each nanostructure fills 1% to 99%, preferably 30% to 60%, of the volume of each void space. Embodiment 14 is the carbon nanotube material of any one of embodiments 6 to 12, wherein each nanostructure fills the entire volume of each void space. Embodiment 15 is the carbon nanotube material of any one of embodiments 1 to 14, wherein the carbon nanotube material is a substantially spherical particle having a diameter of 10 nm to 100 μm. Embodiment 16 is the carbon nanotube material of any one of embodiments 1 to 15, wherein the shell or carbon nanotube network further comprises a polymer, a metal particle, a metal oxide particle, a silicon particle, a carbon-based particle, a metal organic framework particle, a zeolitic organic framework particle, a covalent organic framework particle, or any combination thereof. Embodiment 17 is the carbon nanotube material of any one of embodiments 1 to 16, wherein the carbon nanotubes in the network are single walled carbon nanotubes, multi-walled carbon nanotubes, or both. Embodiment 18 is the carbon nanotube material of any one of embodiments 1 to 17, wherein the shell is a monolith network of carbon nanotubes.

Embodiment 19 is a method of making a multi-core/carbon nanotube shell material, the method comprising: (a) obtaining a composition comprising a plurality of nanostructures dispersed throughout a carbon-containing polymeric matrix; and (b) subjecting the carbon-containing polymeric matrix to a graphitization process to form a shell having a carbon nanotube network from the matrix, wherein a multi-core/carbon nanotube shell material is obtained that includes a shell having a network of carbon nanotubes and a plurality of discrete nanostructure cores contained within and surrounded by the network. Embodiment 20 is the method of embodiment 19, wherein the shell consists essentially of or consists of carbon nanotubes. Embodiment 21 is the method of any one of embodiments 19 to 20, wherein the carbon containing polymeric matrix in step (a) comprises an exchangeable ion. Embodiment 22 is the method of any one of embodiments 19 to 21, wherein the carbon containing polymeric matrix is cross-linked with a cross-linking agent, preferably divinylbenzene. Embodiment 23 is the method of any one of embodiments 19 to 22, wherein the composition in step (a) is obtained by (1) dispersing the nanostructures in a solution comprising a carbon-containing compound and (2) polymerizing the compound. Embodiment 24 is the method of embodiment 23, wherein the solution further comprises a cross-linking agent, preferably divinylbenzene. Embodiment 25 is the method of any one of embodiments 19 to 23, wherein the step (b) graphitization process comprises heating the carbon-containing polymeric matrix to a temperature of 400 to 1000° C. Embodiment 26 is the method of embodiment 25, wherein the nanostructures in step (a) catalyze the graphitization of the matrix. Embodiment 27 is the method of embodiment 25, wherein a metal catalyst is loaded into the matrix prior to or during the step (b) graphitization process to catalyze the graphitization of the matrix. Embodiment 28 is the method of any one of embodiments 19 to 27, further comprising: (c) partially or fully etching away the plurality of nanostructures such that a plurality of discrete void spaces are obtained, wherein the boundary of each discrete void space is defined by the carbon nanotube network. Embodiment 29 is the method of embodiment 28, wherein the plurality of nanostructures are partially etched such that each nanostructure fills 1% to 99%, preferably 30% to 60%, of the volume of each void space. Embodiment 30 is the method of embodiment 28, wherein the plurality of nanostructure cores are fully etched such that each discrete void space has no nanostructure. Embodiment 31 is the method of any one of embodiments 19 to 29, wherein the nanostructures comprises a metal nanoparticle, a metal oxide nanoparticle, a silicon particle, a carbon-based nanoparticle, a metal organic framework nanoparticle, a zeolitic organic framework nanoparticle, a covalent organic framework nanoparticle, or any combination thereof. Embodiment 32 is the method of any one of embodiments 19 to 29 and 31, wherein each nanostructure has a diameter of 1 nm to 1000 nm, preferably 1 nm to 50 nm, or more preferably 1 nm to 5 nm. Embodiment 33 is the method of any one of embodiments 19 to 32, wherein the produced multi-core/carbon nanotube shell material is a substantially spherical particle having a diameter of 10 nm to 100 μm. Embodiment 34 is the method of any one of embodiments 19 to 33, wherein the carbon nanotubes in the network are single walled carbon nanotubes, multi-walled carbon nanotubes, or both. Embodiment 35 is the method of any one of embodiments 19 to 34, wherein the shell is a monolith network of carbon nanotubes.

Embodiment 36 is a multi-core/carbon nanotube shell material made by the process of any one of embodiments 19 to 35. Embodiment 37 is a method for using the carbon nanotube material of any one of embodiments 1 to 18 or the multi-core/carbon nanotube shell material of embodiment 36 in a chemical reaction, the method comprising contacting the material with a reactant feed to catalyze the reaction and produce a product feed. Embodiment 38 is the method of embodiment 37, wherein the chemical reaction comprises a hydrocarbon cracking reaction, a hydrogenation of hydrocarbon reaction, and/or a dehydrogenation of hydrocarbon reaction.

Embodiment 39 is a system for producing a chemical product, the system comprising: (a) an inlet for a reactant feed; (b) a reaction zone that is configured to be in fluid communication with the inlet, wherein the reaction zone comprises the carbon nanotube material of any one of embodiments 1 to 18 or the multi-core/carbon nanotube shell material of embodiment 36; and (c) an outlet configured to be in fluid communication with the reaction zone and configured to remove a product stream from the reaction zone. Embodiment 40 is the system of embodiment 39, wherein the reaction zone is a continuous flow reactor selected from a fixed-bed reactor, a fluidized reactor, or a moving bed reactor.

Embodiment 41 is an energy storage device comprising the carbon nanotube material of any one of embodiments 1 to 18 or the multi-core/carbon nanotube shell material of embodiment 36. Embodiment 42 is the energy storage device of embodiment 41, wherein the energy storage device is a battery. Embodiment 43 is the energy storage device of embodiment 42, wherein the material is comprised in a cathode of the battery. Embodiment 44 is the energy storage device of any one of embodiments 42 to 43, wherein the battery is a rechargeable battery. Embodiment 45 is the energy storage device of embodiment 44, wherein the rechargeable battery is a lithium-ion or lithium-sulfur battery. Embodiment 46 is a controlled released material comprising the carbon nanotube material of any one of embodiments 1 to 18 or the multi-core/carbon nanotube shell material of embodiment 36. Embodiment 47 is a fuel cell comprising the carbon nanotube material of any one of embodiments 1 to 18 or the multi-core/carbon nanotube shell material of embodiment 36. Embodiment 48 is a supercapacitor comprising the carbon nanotube material of any one of embodiments 1 to 18 or the multi-core/carbon nanotube shell material of embodiment 36.

The phrase “distinct void space” refers to a separate empty space present within the carbon nanotube network that has been created by removing (e.g., etching away) a nanostructure from the network. The boundary of the void space is defined by the carbon nanotube network. The distinct void space is greater than any inherent spacing between the outer walls of two or more adjacent carbon nanotubes in the network and is also different than the hollow channels that are inherently present in carbon nanotubes. In preferred instances, the volume of each discrete void space is 1 nm³ to 10⁶ μm³ and/or each discrete void space is substantially spherical.

A carbon nanotube network or CNT network includes a plurality of individual carbon nanotubes that form a network or matrix of CNTs. The CNTs within a CNT network of the present invention can be in contact with one another, can be aligned in substantially the same direction, and/or can be randomly oriented. In a preferred aspect, the CNT network has a substantially spherical shape and consists essentially of or consists of a plurality of CNTs.

A multi-core/carbon nanotube material (or structure) or multi-core/shell material (or structure) of the present invention has a carbon nanotube network with a plurality of individual cores, where each core (i.e., a nanostructure, preferably a nanoparticle) is encompassed within the carbon nanotube network and at least 50% to 100%, preferably 60% to 90% of the surface of each core contacts the carbon nanotube network. A non-limiting illustration of a multi-core nanotube structure of the present invention is provided in FIG. 1.

A multi-yolk/carbon nanotube material (or structure) or multi-yolk/shell material (or structure) of the present invention has a carbon nanotube network with a plurality of individual yolks, where each yolk (i.e., a nanostructure, preferably a nanoparticle) is encompassed within the carbon nanotube network and less than 50% of the surface of each yolk contacts the carbon nanotube network. A non-limiting illustration of a multi-yolk nanotube structure of the present invention is provided in FIG. 2.

A multi-void/carbon nanotube material (or structure) or multi-void/shell material (or structure) of the present invention has a carbon nanotube network with a plurality of discrete void spaces contained within and surrounded by the network, wherein the boundary of each void space is defined by the carbon nanotube network. A non-limiting illustration of a multi-void nanotube structure of the present invention is provided in FIG. 3.

In certain instances, the carbon nanotube materials of the present invention can have a mixture of cores, yolks and/or void spaces. These can be referred to as mixed core/yolk materials (or structures), mixed core/void materials (or structures), mixed yolk/void materials (or structures), or mixed core/yolk/void materials (or structures). In such embodiments (1) at least 50% to 100%, preferably 60% to 90% of the surface of each core contacts the carbon nanotube network, (2) less than 50% of the surface of each yolk contacts the carbon nanotube network, and/or (3) each void space is empty. A non-limiting illustration of a mixed core/yolk/void material of the present invention is provided in FIG. 4.

Determination of whether a core, yolk, or void space is present in the carbon nanotube materials of the present invention can be made by persons of ordinary skill in the art. One example is visual inspection of a transition electron microscope (TEM) or a scanning transmission electron microscope (STEM) image of a carbon nanotube material of the present invention and determining whether a void space is present or determining whether at least 50% (core) or less (yolk) of the surface of a given nanostructure (preferably a nanoparticle) contacts the carbon nanotube network.

“Nanostructure” refers to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof. “Nanoparticles” include particles having an average diameter size of 1 to 1000 nanometers.

The term “about” or “approximately” are defined as being close to as understood by one of ordinary skill in the art, and in one non-limiting embodiment the terms are defined to be within 10%, preferably within 5%, more preferably within 1%, and most preferably within 0.5%.

The term “substantially” and its variations are defined to include the ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The carbon nanotube material of the present invention and uses thereof can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the carbon nanotube material of the present invention is a plurality of discrete void spaces, cores, and/or yolks contained within and surrounded by the carbon nanotube network.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is an illustration of a cross-sectional view of a multi-core/carbon nanotube shell material of the present invention.

FIG. 2 is an illustration of a cross-sectional view of a multi-yolk/carbon nanotube shell material of the present invention.

FIG. 3 is an illustration of a cross-sectional view of a multi-void/carbon nanotube shell material of the present invention.

FIG. 4 is an illustration of a cross-sectional view of a mixed core/yolk/void/carbon nanotube (CNT) shell material of the present invention.

FIG. 5 is a schematic of an embodiment of a method of making the carbon nanotube materials of the present invention.

FIG. 6 is a Fourier Transform infrared (FT-IR) spectrum of unmodified and modified silica nanoparticles of the present invention.

FIG. 7 is a scanning electron microscope (SEM) image of modified SiO₂ particles of the present invention.

FIG. 8 is a transmission electron microscope (TEM) image of modified SiO₂ particles of the present invention.

FIG. 9 is a SEM image of m-SiO₂/polystyrene (PS) particles of the present invention.

FIG. 10 is a TEM image of m-SiO₂/PS particles of the present invention.

FIG. 11 is a FT-IR spectrum of a) polystyrene, b) SiO₂ and c) m-SiO₂/PS of the present invention.

FIG. 12 is a SEM image of m-SiO₂/CNT of the present invention.

FIG. 13 is a TEM image of m-SiO₂/CNT of the present invention.

FIG. 14 is a high-magnification TEM image of m-SiO₂/CNT.

FIG. 15 is a Raman spectrum for commercial CNT and synthesized m-SiO₂/CNT of the present invention.

FIG. 16 is a SEM image of CNT hollow spheres of the present invention.

FIG. 17 is a TEM image of CNT hollow spheres of the present invention.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

The present invention allows for the preparation and use of a variety of different structures for CNT materials, thereby allowing for increased utilization of the unique mechanical, chemical, optical and electrical properties of CNTs. In particular, the CNT materials of the present invention can be tuned or designed for a particular application. This tunability can be derived from the process of making the materials of the present invention, which allows for the creation of a base multi-core/carbon nanotube structure that can be further modified to a multi-yolk/carbon nanotube structure, a multi-void carbon nanotube structure, and/or mixed core/yolk, core/void, yolk/void, and core/yolk/void structures. The cores and yolks can be designed for a particular application (e.g., electrical storage applications, catalytic reactions, etc.) and can have increased stability through separation of the core and yolk nanostructures, thereby reducing or preventing crystal growth and sintering of the core and yolk nanostructures. Still further, the carbon nanotube networks or shells of these structures have good flow flux properties due to the CNT network and the hollow channels of the individual CNTs, thereby allowing access to the cores, yolks, and void spaces. In addition, the networks or shells can be tuned to have a desired thickness to maximize interfacial chemistry.

These and other non-limiting aspects of the present invention are discussed in further detail in the following sections with reference to the Figures.

### A. Carbon Nanotube Materials

1. Multi-Core/Carbon Nanotube Structures

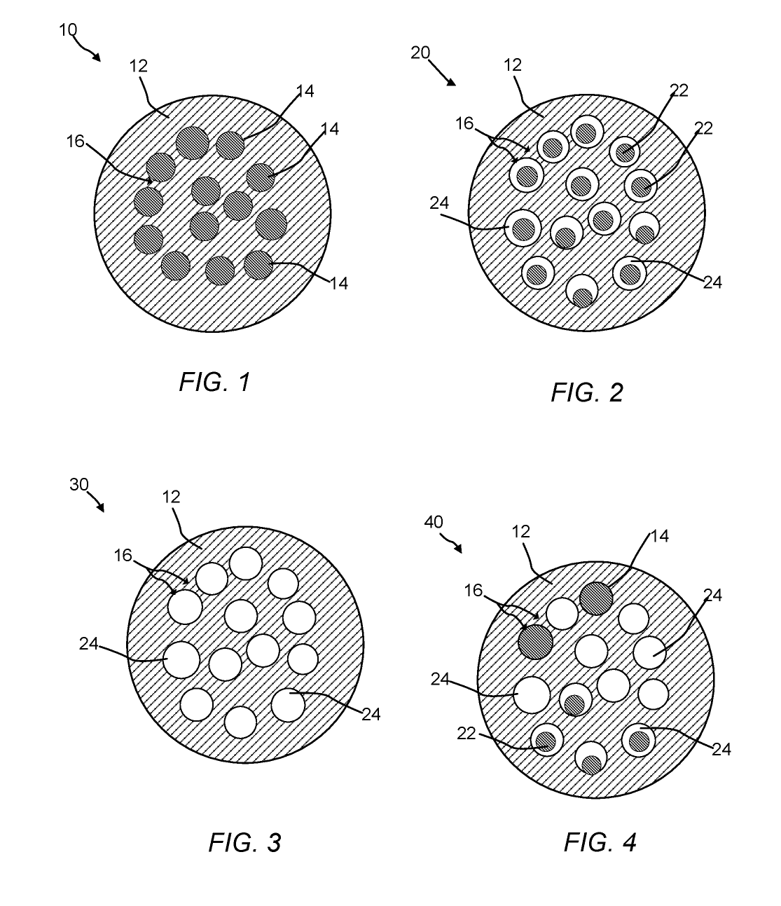

A multi-core/carbon nanotube material of the present invention includes a carbon nanotube network of carbon nanotubes and a plurality of cores each contained within and surrounded by the network. The boundary of each core is defined by the carbon nanotube network, thereby providing for a pomegranate-like structure. In a particular embodiment, the carbon nanotube material is a substantially spherical particle having a diameter of 1 nm to 100,000 nm, 10 nm to 10,000 nm, or 100 nm to 1,000 nm or any range or value there between. FIG. 1 is a cross-sectional view of an illustration of a multi-core/carbon nanotube material 10 having a carbon nanotube network or shell 12, nanostructure core 14 and boundaries 16. The shell 12 is a network of carbon nanotubes (e.g., a monolith). The carbon nanotubes in the network can be single wall nanotubes or multi-wall nanotubes or a mixture thereof. The boundaries 16 are the portions of the carbon nanotube network that surrounds the nanostructure core 14. The nanostructure cores 14 are substantially or completely separated from one another in the carbon nanotube network. A diameter of the nanostructure core 14 can range from 1 nm to 1000 nm, preferably 1 nm to 50 nm, or more preferably 1 nm to 5 nm or 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 nm, or any value or range there between. As shown, at least 50% of the surface area of each nanostructure core 14 is in contact with the carbon nanotube network 12 at the boundaries 16. In some embodiments, 50% to 100%, 50% to 99%, 60% to 95%, or 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9% or 100% of the surface area of each nanostructure core 14 contacts the carbon nanotube network 12 at the boundary 16. The amount of nanostructure cores that can be present in the carbon nanotube network can range from 2 to 10,000, from 10 to 1000, from 20 to 500, 30 to 400, 50 to 500, 60 to 400, 70 to 300, 80 to 200, 90 to 100 or any value or range there between.

2. Multi-Yolk/Carbon Nanotube Structures

A multi-yolk/carbon nanotube material of the present invention includes nanostructures present within a void space of the carbon nanotube network, thereby providing for a pomegranate-like structure with void spaces. FIG. 2 is cross-sectional illustration of such a material 20. In FIG. 2, carbon nanotube material 20 has a carbon nanotube network or shell 12, a plurality of nanostructure yolks 22, a plurality of void spaces 24, and boundaries 16. Void spaces 24 can be formed by removal of portions of the nanostructures through an etching process, which is described in greater detail below. The nanostructure yolks 22 can be positioned in the void spaces 24 of the carbon nanotube network. The yolks are separated from each other via the carbon nanotube network 12. The boundary 16 is formed by the carbon nanotube network 12. In some embodiments, the nanostructure yolks 22 do not contact the boundaries 16. In other embodiments, less than 50% of the surface area of each nanostructure yolk 22 is in contact with the carbon nanotube network 12 at the boundaries 16. In some embodiments, 1% to 49%, 30% to 40%, or 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 36%, 37%, 38%, 39%, 40%, 41%, 42%, 43%, 44%, 45%, 46%, 47%, 48%, of the surface area of each nanostructure yolk 22 contacts the carbon nanotube network 12 at the boundary 16. A diameter of the nanostructure yolks 22 can range from 1 nm to 1000 nm, preferably 1 nm to 50 nm, or more preferably 1 nm to 5 nm or 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 nm, or any value or range there between. The amount of nanostructure yolks 22 in a carbon nanotube network 12 can range from 2 to 10,000, from 10 to 1000, from 20 to 500, 30 to 400, 50 to 500, 60 to 400, 70 to 300, 80 to 200, 90 to 100 or any value or range there between.

3. Multi-Void/Carbon Nanotube Structures

A multi-void/carbon nanotube material of the present invention includes a plurality of discrete or separate void spaces within the carbon nanotube network, thereby providing a honeycomb-like structure. FIG. 3 is cross-sectional illustration of a multi-void/carbon nanotube structure 30 having the carbon nanotube network 12, a plurality of void spaces 24, and boundaries 16. Void spaces 24 can be formed by removal of portions of nanostructure cores 14 and yolks 22 through an etching process, which is described in greater detail below. The amount of void spaces 24 in a carbon nanotube network can range from 2 to 10,000, from 10 to 1000, from 20 to 500, 30 to 400, 50 to 500, 60 to 400, 70 to 300, 80 to 200, 90 to 100 or any value or range there between. The average volume of the void spaces can be adjusted or tuned to meet specific requirements for chemical or material applications. In some instances, the average volume of the void spaces is 1 nm³ to 10⁶ μm³, 5 nm³ to 10⁵ μm³, 10 nm³ to 10⁴ μm³, 20 nm³ to 10³ μm³, 50 nm³ to 10² μm³, or any range or value there between.

4. Mixed Core/Yolk/Void Nanotube Structures

In some embodiments, the carbon nanotube material of the present invention can have a mixture of cores, yolks, and/or void spaces. FIG. 4 is a cross-sectional illustration of a carbon nanotube material 40 having a core/yolk/void structure, where cores 14, yolks 22, and voids 24 are present within the carbon nanotube network 12. Although not shown, additional mixed structures such as mixed core/yolk, mixed core/void, and mixed yolk/void structures are also contemplated.

5. Additional Structures

In addition to the structures discussed above, a multitude of other structures for the materials of the present invention can be obtained. By way of example, any one of the aforementioned multi-core, multi-yolk, multi-void, and mixed structures described above can be subjected to a further coating process. For instance, a silica coating, a titania coating, or an alumina coating, or any combination thereof, can be added to the materials of the present invention. Channels or pores can be created by selectively removing portions of the coatings.

In addition, multiple layered architectures of the aforementioned structures can be obtained. By way of example, the processes for making these structures is described in detail below. The starting nanomaterials in step 1 discussed below could be any one of the multi-core, multi-yolk, multi-void, and mixed structures. Therefore, multi-layered architectures can be obtained where, for example, the inner layer is a multi-yolk/carbon nanotube structure, and a second outer layer is a multi-void/carbon nanotube structure. Any combination of multiple layers are envisioned in the context of the present invention and can be obtained by simply repeating the process steps discussed below.

### B. Preparation of Carbon Nanotube Materials

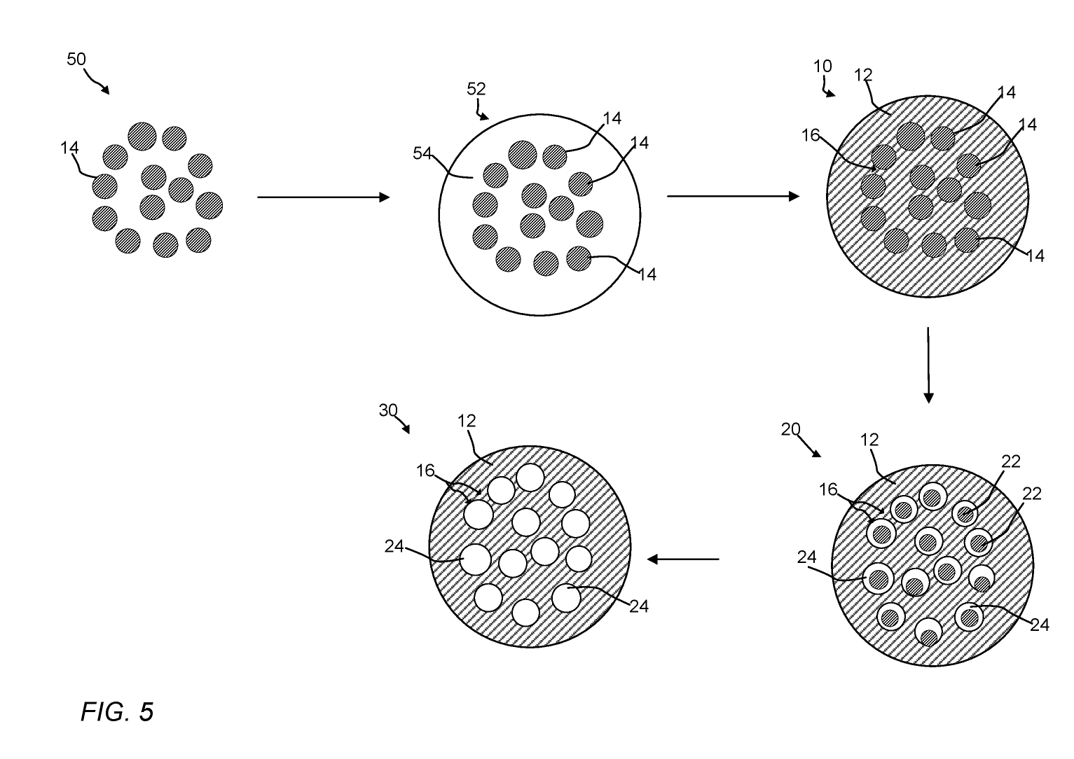

FIG. 5 is a schematic of a method of preparing carbon nanotube materials 10, 20, 30, and 40 of the present invention. Nanostructures 14 can be made according to conventional processes (e.g., metal nanostructures made using alcohol or other reducing processes) or purchased through a commercial vendor.

1. Formation of a Composite Nanostructure/Polymeric Matrix

In step 1, nanostructures 14 can be dispersed in a solution having carbon-containing compounds (e.g., a solution of one or more monomers, initiator, and/or a crosslinking agent) and subjected to conditions suitable to polymerize the carbon-containing compounds to produce a composite nanostructure/polymeric matrix 54 containing material 52. This results in the nanostructures 14 being dispersed throughout the polymeric matrix 54 to produce a composite nanostructure/polymeric matrix material 52. In one instance, nanostructures 14 can be dispersed in a mixture of solvent, water, one or more monomers, and/or a crosslinking agent using a Sonic Dismembrator (Fisher Scientific, Model 550, U.S.A.). The resulting mini-emulsions can be purged with an inert gas (e.g., nitrogen) for a period of time (e.g., 10 min to 60 min). After adding the initiator, (e.g., potassium persulfate (KPS, about 0.1 wt %), or 2,2′-azobis(2-methylpropionitrile (AIBN)), the mixture can be heated to the appropriate temperature for polymerization (e.g., 50° C. to 100° C., or 60° C. to 80° C., or about 70° C.). The resulting particles can be separated from the reaction mixture using known separation methods (e.g., centrifugation, filtration, and the like).

In some embodiments, the polymer-coated particles can be subjected to a cross-linking step. By way of example, the polymer coated particles can be adding to a solvent (e.g., chloroform) and contacted with a cross-linking agent (e.g., AlCl₃). The mixture can be heated (e.g., refluxed) under an inert atmosphere until the desired amount of crosslinking has occurred. (e.g., overnight, 10 to 12 hours). The solvent may be removed and the cross-linked silica particles can be washed with dilute acid (e.g., dilute HCl), collected (e.g. centrifuged), and washed with solvent (e.g. ethanol) to remove the water. The resulting silica/polymer particles can be dried under vacuum (e.g., 60° C. under vacuum overnight).

a. Carbon Containing Compounds Used to Form the Matrix

The carbon-containing polymeric matrix can be formed from carbon containing compounds that form a polymeric matrix having ion exchange capabilities. Non-limiting examples of such compounds include functionalized polystyrene polymers, a functionalized siloxane-based polycarbonate polymer, sodium polystyrene sulfonate, amino-functionalized polystyrene resins, 2-acrylamido-2-methylpropane sulfonic acid, acrylic acid polymers, methacrylic acid polymers, or any combination thereof) can be used as a carbon source for formation of the carbon nanotubes shell. These materials are commercially available from numerous commercial sources, for example, SABIC Innovative Plastics (USA), Dow Chemical (USA), Sigma Aldrich® (USA), BioRad (USA), Rapp Polymere GmbH (Germany). Crosslinking agents can be used to cross link the polymeric material. Non-limiting examples of cross-linking agent include divinylbenzene and benzoyl peroxide, which are commercially available from Sigma Aldrich® (USA) or Merck (Germany).

A non-limiting example of a ion-exchanged compound is production of iron-containing polymer coated silica particles (e.g., grafted SiO₂/polystyrene particles can be ion-exchanged with potassium ferricyanide to obtain grafted SiO₂/polystyrene-iron particles). SiO₂/polystyrene particles can be mixed with a solvent (e.g., triethylamine and water) for about 24 hours at 20° C. to 35° C., and then washed with water to a neutral pH is obtained. The resulting solid can be contacted with a basic solution (e.g., NaOH) for about 12 hours and then isolated (e.g., centrifuged), and then washed with water until a neutral pH is obtained. The base treated particles can be contacted with an ion-exchange agent (e.g. potassium ferricyanide) for about 24 hours. The resulting particles can be isolated and washed with water to a neutral pH (e.g., pH of about 7) and dried to remove the water (e.g., heated to 55 to 70° C. overnight under vacuum).

b. Nanostructure Shapes and Materials

Non-limiting examples of nanostructures that can be used in this step include structures having a variety of shapes and/or made from a variety of materials. By way of example, the nanostructures can have the shape of a wire, a particle (e.g., having a substantially spherical shape), a rod, a tetrapod, a hyper-branched structure, a tube, a cube, or mixtures thereof. In particular instance, the nanostructures are nanoparticles that are substantially spherical in shape. Selection of a desired shape has the ability to tune or modify the shape of the resulting void spaces 24.

Non-limiting embodiments of materials that can be used include metals, metal oxides, carbon-based materials, metal organic frameworks, zeolitic imidazolted frameworks, covalent organic frameworks, and any combination thereof. Examples of metals include noble metals, transition metals, or any combinations or any alloys thereof. Noble metals include osmium (Os), palladium (Pd), platinum (Pt), gold (Au), rhodium (Rh), ruthenium (Ru), rhenium (Re), iridium (Ir) or any combinations or alloys thereof. Transition metals include silver (Ag), iron (Fe), copper (Cu), nickel (Ni), zinc (Zn), manganese (Mn), chromium (Cr), molybdenum (Mo), tungsten (W), or tin (Sn), or any combinations or alloys thereof. In some embodiments, the nanostructure includes 1, 2, 3, 4, 5, 6, or more transition metals and/or 1, 2, 3, 4 or more noble metals. The metals can be obtained from metal precursor compounds. For example, the metals can be obtained as a metal nitrate, a metal amine, a metal chloride, a metal coordination complex, a metal sulfate, a metal phosphate hydrate, metal complex, or any combination thereof. Examples of metal precursor compounds include, nickel nitrate hexahydrate, nickel chloride, cobalt nitrate hexahydrate, cobalt chloride hexahydrate, cobalt sulfate heptahydrate, cobalt phosphate hydrate, platinum (IV) chloride, ammonium hexachloroplatinate (IV), sodium hexachloroplatinate (IV) hexahydrate, potassium hexachloroplatinate (IV), or chloroplatinic acid hexahydrate. These metals or metal compounds can be purchased from any chemical supplier such as Sigma-Aldrich (St. Louis, Mo., USA), Alfa-Aeaser (Ward Hill, Mass., USA), and Strem Chemicals (Newburyport, Mass., USA). Metal oxides include silica (SiO₂), alumina (Al₂O₃), titania (TiO₂), zirconia (ZrO₂), germania (GeO₂), stannic oxide (SnO₂), gallium oxide (Ga₂O₃), zinc oxide (ZnO), hafnia (HfO₂), yttria (Y₂O₃), lanthana (La₂O₃), ceria (CeO₂), or any combinations or alloys thereof.

MOFs are compounds having metal ions or clusters coordinated to organic molecules to form one-, two-, or three-dimensional structures that can be porous. In general, it is possible to tune the properties of MOFs for specific applications using methods such as chemical or structural modifications. One approach for chemically modifying a MOF is to use a linker that has a pendant functional group for post-synthesis modification. Any MOF either containing an appropriate functional group or that can be functionalized in the manner described herein can be used in the disclosed carbon nanotubes Examples include, but are not limited to, IRMOF-3, MOF-69A, MOF-69B, MOF-69C, MOF-70, MOF-71, MOF-73, MOF-74, MOF-75, MOF-76, MOF-77, MOF-78, MOF-79, MOF-80, DMOF-1-NH₂, UMCM-1-NH₂, and MOF-69-80. Non-limiting examples of zeolite organic frameworks include zeolite imidazole framework (ZIFs) compounds such as ZIF-1, ZIF-2, ZIF-3, ZIF-4, ZIF-5, ZIF-6, ZIF-7, ZIF-8, ZIF-9, ZIF-10, ZIF-11, ZIF-12, ZIF-14, ZIF-60, ZIF-62, ZIF-64, ZIF-65, ZIF-67, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-86, ZIF-90, ZIF-91, ZIF-92, ZIF-93, ZIF-95, ZIF-96, ZIF-97, ZIF-100 and hybrid ZIFs, such as ZIF-7-8, ZIF-8-90. Covalent organic frameworks (COFs) are periodic two- and three-dimensional (2D and 3D) polymer networks with high surface areas, low densities, and designed structures. COFs are porous, and crystalline, and made entirely from light elements (H, B, C, N, and O). Non-limiting examples of COFs include COF-1, COF-102, COF-103, PPy-COF 3 COF-102-C₁₂, COF-102-allyl, COF-5, COF-105, COF-108, COF-6, COF-8, COF-10, COF-11 Å, COF-14 Å, COF-16 Å, OF-18 Å, TP-COF 3, Pc-PBBA, NiPc-PBBA, 2D-NiPc-BTDA COF, NiPc COF, BTP-COF, HHTP-DPB, COF-66, ZnPc-Py, ZnPc-DPB COF, ZnPc-NDI COF, ZnPc-PPE COF, CTC-COF, H2P-COF, ZnP-COF, CuP-COF, COF-202, CTF-1, CTF-2, COF-300, COF-LZU, COF-366, COF-42 and COF-43.

The amount of nanostructures (e.g., nanoparticles) in the carbon nanotube material depends, inter alia, on the use of the carbon nanotube material. In some embodiments when the carbon nanotube material is used as a catalyst, the amount of catalytic metal present in the particle(s) in the core or yolk ranges from 0.01 to 100 parts by weight of “active” catalyst structure per 100 parts by weight of catalyst, from 0.01 to 5 parts by weight of “active” catalyst structure per 100 parts by weight of catalyst. If more than one catalytic metal is used, the molar percentage of one metal can be 1 to 99 molar % of the total moles of catalytic metals in the catalytic core or yolk(s).

The metal or metal oxide nanostructures can be stabilized with the addition of surfactants (e.g., CTAB, PVP, etc.) and/or through controlled surface charge. When surfactants are used, a yolk-shell structure or a multi-void structure can be obtained after etching, which is described below in more detail. In other examples, the “active” portion of the nanostructure can be surrounded by a metal oxide (e.g., silica) and the silica can be removed during the etching process to form a yolk-shell structure. When a controlled surface charge process is used, a core-shell structure can be obtained.

The nanostructures can also include a catalyst (e.g., iron) capable of catalyzing the formation of the carbon nanotubes from the carbon-containing polymeric matrix in addition to the “active” material needed for the targeted product. In some embodiments, the catalyst is the nanostructure and is removed to form the void spaces in the carbon nanotube material.

2. Graphitization of the Polymeric Matrix and Formation of the Carbon Nanotube Network

In step 2, after the composite nanostructure/polymeric matrix material 52 is formed, it can then be subjected to a graphitization process to convert the matrix 54 into the carbon nanotube network 12. In one non-limiting aspect, the graphitization process described in Zhang et al. (Angew. Chem. Int. ed., 2012, 51, 7581-7585) can be used. By way of example, the polymeric sphere 52 can be subjected to an ion-exchange process to load a graphitization catalyst (e.g., iron) into said matrix 54. For instance, a potassium ferricyanide solution can be used to load iron into a styrene-divinylbenzene copolymer matrix as described above. The weakly adsorbed ions can then be removed through a water wash and the ion-exchanged polymeric matrix can be dried. In some embodiments, however, an ion exchange process may not be necessary where the nanostructures 14 have a catalyst (e.g., the nanostructures 14 can be coated with a catalyst such as iron or can be made entirely of a catalyst).

The composite material 52 can then be heated at a temperature of 400° C. to 1000° C., 500° C. to 950° C., 600° C. to 900° C., or 800° C. under an inert atmosphere (e.g., argon atmosphere) for 0 to 20 hours to graphitize the carbon-containing compound into a carbon nanotube network 12. A rate of heating can range from 5 to 15° C. per minute (° C./min). In some embodiments, the composite material can be heated to a first temperature of 300° C. to 350° C. or about 310° C. at a rate of 1 to 3° C./min, or about 2° C./min, heated to a second temperature of 360 to 400° C., or about 370° C. at rate of 1 to 3° C./min, or about 2° C./min, held at 370° C. (e.g., 1 to 3, or about 2 h), heated to a third temperature of 380 to 820 or about 800° C. at rate of 5 to 15° C./min or about 10° C./min and held at 800° C. for a desired amount of time (e.g. 3 to 5 hour, or about 4 hour). The carbon nanotube network can be formed around the nanostructures 14, thereby isolating the nanostructures 14 from each other and creating the multi-core/carbon nanotube structures 10. The produced structure 10 can be cooled steadily to room temperature and the graphitization catalyst can be removed, if necessary, by refluxing in an appropriate catalyst removing solution (e.g., a solution of HNO₃ to remove an iron catalyst).

Notably, the carbon nanotube network 12 is comprised mainly of individual carbon nanotubes (either single walled or multi-walled CNTs can be used or combinations thereof). The network 12 acts as a continuous phase or matrix in which cores 14, yolks, 22, and/or voids 24 are dispersed throughout the network. In preferred embodiments, the carbon nanotube network 12 consists essentially of carbon nanotubes or is entirely made up of carbon nanotubes. In other embodiments, however, the network 12 can be impregnated or loaded with other materials in addition to the carbon nanotubes. By way of example, during the step 1 process, additional materials can be dispersed into the solution having carbon containing compounds. Alternatively, and after step 2 has been performed, the outer surface of the produced carbon nanotube material can be loaded with the additional materials. In either instance, the additional materials can be other polymers, metal particles, metal oxide particles, silicon particles, carbon-based particles, MOFs, ZIFs, COFs, or any combination thereof.

Further, the thickness of the carbon nanotube network 12 can be modified or tuned as desired by limiting the amount of the solution used in step 1 or by increasing the amount and or size of the nanomaterials used in step 1. In either instance, the ratio of the solution having the carbon containing compound to the nanomaterials dispersed therein can result in a desired thickness of the resulting network 12. By way of example, the thickness of the network can be 0.5 nm to 1000 nm, 10 nm to 100 nm, 10 nm to 50 nm, or 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, 35 nm, 36 nm, 37 nm, 38 nm, 39 nm, 40 nm, 41 nm, 42 nm, 43 nm, 44 nm, 45 nm, 46 nm, 47 nm, 48 nm, 49 nm, 50 nm, or any range or value there between. In some embodiments, the network can be considered to be “thin,” “medium,” or “thick”. A thin network 12 can have a thickness of several nanometers, or 0.5 nm to 10 nm. A thick network 12 can have a thickness of 50 nm to 1000 nm. A medium network can have a thickness that overlaps the thin and thick ranges (i.e., 10 nm to 50 nm). By controlling the thickness of the network, the interfacial chemistry of the produced material can be obtained.

In preferred aspects, the carbon nanotube network has a substantially spherical shape. However, other shapes are contemplated in the context of the present invention. By way of example, shapes such as cubes, pyramids, rectangular box, etc. can be used. Notably, the diffusion transport (flow flux or permeability) of the carbon nanotube network 12 can range from 1×10⁻⁶ to 1×10⁻⁴ mol m⁻²s⁻¹Pa⁻¹. Still further, the network 12 can have a surface area of 200 to 1000 m²g⁻¹, 250 to 900 m²g⁻¹, 300 to 800 m²g⁻¹, or 400 to 700 m²g⁻¹. The produced carbon nanotubes can be open ended and can have a diameter of from 100 nm to 300 nm.

3. Removal of the Nanostructure Cores

In steps 3 and 4, the multi-core/carbon nanotube material 10 can be converted into the multi-yolk/carbon nanotube structure 20 (step 3) or the multi-void/carbon nanotube structure 30 (step 4) by contacting the multi-core/nanotube structure 10 with an etching solution for a desired amount of time (e.g., for 5 to 30 minutes) to partially or completely remove the nanoparticle from the carbon nanotube network 12. Alternatively, higher concentration of the etching agent, or more powerful etching agents can be used at a similar etching period of time to obtain the desired core/CNT shell material. Non-limiting examples of etching agents that can be used include hydrofluoric acid (HF), ammonium fluoride (NH₄F), the acid salt of ammonium fluoride (NH₄HF₂), sodium hydroxide (NaOH), nitric acid (HNO₃), hydrochloric acid (HCl), hydroiodic acid (HI), hydrobromic acid (HBr), boron trifluride (BF₃), sulfuric acid (H₂SO₄), acetic acid (CH₃COOH), formic acid (HCOOH), or any combination thereof. In a certain embodiments, HF, NH₄F, NH₄HF₂, NaOH or any combination thereof can be used (e.g., in instances where a silica coating is removed from the surface of the nanostructure). In some embodiments, HNO₃, HCl, HI, HBr, BF₃, H₂SO₄, CH₃COOH, HCOOH, or any combination thereof can be used (e.g., to remove an alumina coating from the surface of the nanostructure). In another embodiment, a chelating agent (e.g., EDTA) for Al³⁺ can be added as an aid for faster etching of alumina in addition of above stated acids.

Removal of a portion of the nanostructures 14 (e.g., removal of a silica coating surrounding a metal nanostructure) produces the multi-yolk/carbon nanotube structure 20. Multi-yolk/carbon nanotube structure 20 can then be subjected to a different etching or the same process to remove all the nanostructures to form a multi-void/carbon nanostructure 30. Complete removal of the nanostructure 14 results in the multi-void/carbon nanotube structure 30. In instances, where a mixture of different nanomaterials 14 are used, the mixed core/yolk/void structure 40 or mixed core/yolk, core/void, or yolk/void structures can be obtained. By way of example, the core/yolk/void/structure can be made by using a mixture three nanomaterials, wherein the first nanomaterial is not affected by the etching solution (e.g., a metal), the second nanomaterial includes a coating affected by the etching solution (e.g., a metal coated with silica), and a third nanomaterial is made up of a material that is affected by the etching solution (e.g., a silica particle). Therefore, the etching process would result in the core/yolk/void structure 40. After the etching process, the produced carbon nanotube material can be isolated from the etching solution using conventional separation techniques (e.g., centrifugation) and washed to remove any residual etching solution (e.g., washed with alcohol) and dried. In some embodiments, the carbon nanomaterials 20, 30, 40 can be subjected to steps 1 through 4 to form layers of carbon nanotube materials. By way of example, carbon nanotube material 20 can be subjected the steps 1 through 4 with carbon nanotube material 20 being used as the nanoparticle. The resulting carbon nanotube material would have two layers of a carbon nanotube network surrounding the nanostructure.

### C. Use of the Carbon Nanotube Materials

The produced carbon nanotube material of the present invention can be used in a variety of chemical reactions. Non-limiting examples of chemical reactions include a hydrocarbon hydroforming reaction, a hydrocarbon hydrocracking reaction, a hydrogenation of hydrocarbon reaction, and/or a dehydrogenation of hydrocarbon reaction. The methods used to prepare the nanoparticle core-shell catalysts can tune the size of the core, the catalytic metal particles, dispersion of the catalytic metal-containing particles in the core, the porosity and pore size of the shell or the thickness of the shell to produce highly reactive and stable multi-core/carbon nanotube shell catalysts for use in a chosen chemical reaction.

The carbon nanotube materials can also be used in a variety of energy storage applications (e.g., fuel cells, batteries, supercapacitors, and electrochemical capacitors), optical applications, and/or controlled release applications. In some aspects, a lithium ion battery includes (e.g., in a cathode) the previously described carbon nanotube material or multi-core/carbon nanotube shell material. In some embodiments, the carbon nanotube material includes one or more nanostructures suitable for controlled release including those for medical applications.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Synthesis of Modified Silica Nanoparticles

A mixture of tetraethyl orthosilicate (TEOS, 80 mL) in ethanol (100 mL) was added dropwise to a mixture of ethanol (500 mL), water (50 mL), and ammonium (8 mL, 25% aqueous solution, ultrasonic 30 minutes) with vigorous stirring at room temperature. After 6 hours, [3-(methacryloyloxy)propyl]trimethoxysilane (MPS, 12 mL) was added and the reaction was stirred for a further 72 hours. The resultant silica particles were then purified by three cycles of centrifugation, decantation, and resuspension in ethanol with ultrasonic bathing. The MPS modified silica particles were dried in a vacuum oven at 50° C. until constant weight.

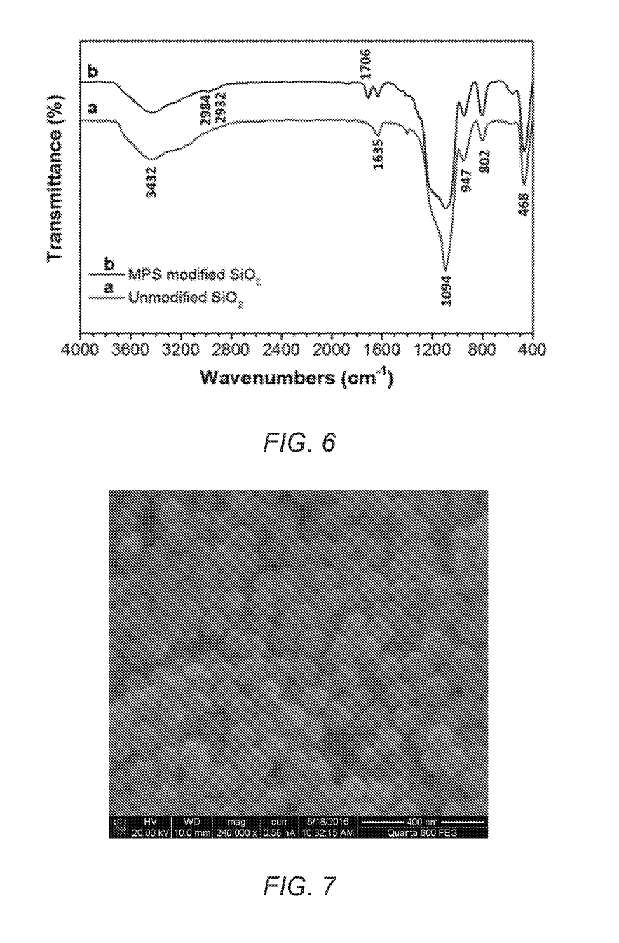

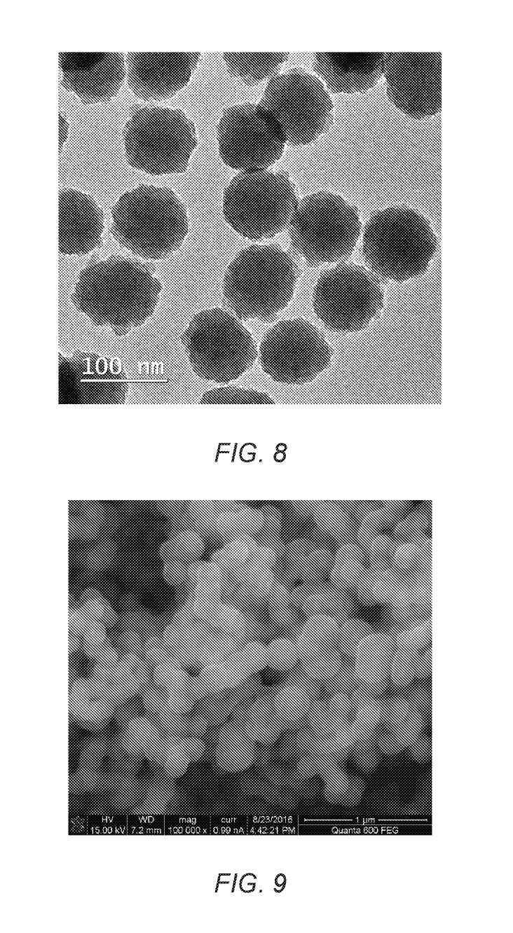

FIG. 6 shows the FT-IR spectra of unmodified and modified silica nanoparticles. The both FT-IR spectra of unmodified and MPS modified silica nanoparticles exhibit a very strong absorption band at 1094 cm⁻¹ attributing to the stretching vibration of Si—O—Si groups, while the bending modes of these groups correspond to the band observed at 469 cm⁻¹. The peak at 802 cm⁻¹ is assigned to Si—O stretching vibration. The absorption bands at 3432 and 1635 cm⁻¹ were due to the H—O—H stretching and bending modes of the absorbed water, respectively. In the spectra of modified silica particles, the absorption at 1706 and 2932 cm⁻¹ are related to the C═O functional groups and stretching vibrations of —CH₂. The peak located at 2984 cm⁻¹ is assigned to symmetrical vinyl C—H stretching. The spectrum confirms that the organic functional groups were successfully incorporated onto the surface of silica nanoparticles. FIG. 7 and FIG. 8 show the SEM and TEM images of MPS modified SiO₂ particles with diameter of around 80 nm.

### Example 2

### (Synthesis of SiO₂/Polystyrene Co-Polymer Multi-Core/Shell Particles (m-SiOz/PS))

MPS grafted silica particles (1 g, Example 1) were dispersed in 80 ml of ethanol by Sonic Dismembrator (Fisher Scientific, Model 550), and then polyvinylpyrrolidone (1 g, PVP, Mw=36000), 2,2′-azobis(2-methylpropionitrile) (AIBN, 0.2 g), styrene (10 mL) and divinylbenzene (1 mL) was added. After bubbling nitrogen through the reaction medium for 30 min, the polymerization was carried out at 70° C. for 24 hours. The white precipitate was centrifuged, washed sequentially with ethanol four times to remove the excess monomer and initiator, and subsequently dried in air to produce m-SiO₂/PS.

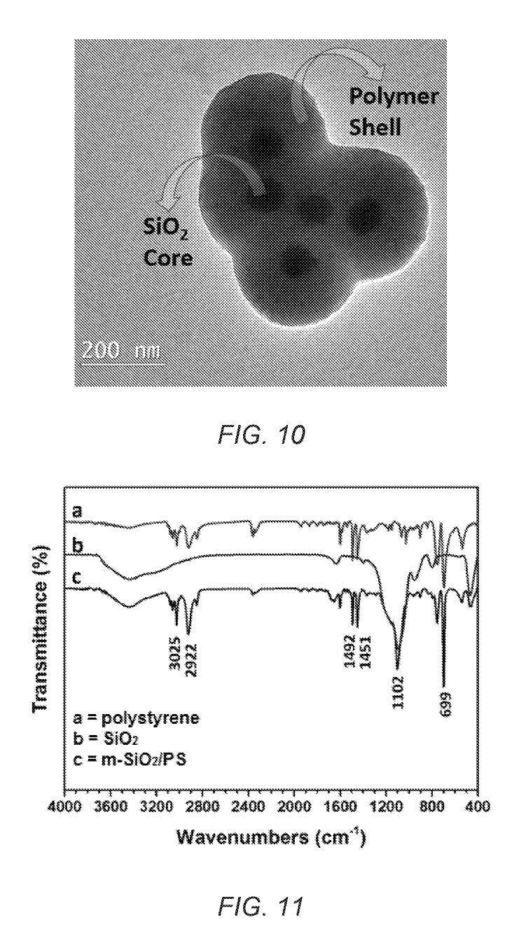

FIG. 9 shows the SEM image of SiO₂/polystyrene-copolymer multi-core/shell particles (m-SiO₂/PS). FIG. 10 shows the TEM image of m-SiO₂/PS. Multi-SiO₂ cores were observed. FIG. 11 shows the FT-IR spectra of a) polystyrene, b) SiO₂ and c) m-SiO₂/PS. The absorption at 3025 cm⁻¹ was attributed to the aromatic C—H stretching. The peak at 2922 cm-1 was related to the stretching vibrations of —CH₂. The peak at 1492 cm⁻¹ and 1451 cm⁻¹ are attributed aromatic C═C stretching. The absorption band at 1102 cm−1 can be ascribed to the stretching vibration of Si—O—Si groups. The peak at 699 cm⁻¹ was due to the out-of-plane ring deformation for a mono-substituted phenyl group of the polystyrene.

### Example 3

### (Post-Cross-Linking of m-SiOz/PS (m-SiO₂/X-PS))

A mixture of m-SiO₂/PS of Example 2 (1 g), HCCl₃ (60 mL) and AlCl₃ (3 g) in a 250 mL, three-necked, round bottom flask equipped with a polytetrafluoroethylene-bladed paddle and a water-cooled condenser was refluxed overnight under N₂. After removed the solvent, HCl (2%, 50 mL) was added. The product was collected and purified by centrifuge and washing with ethanol (15 mL×3). The resultant yellow powder was collected and dried at 60° C. under vacuum overnight.

### Example 4

### (Ion-Exchange of m-SiO₂/X-PS (m-SiOz/X—PS-Fe))

A mixture of m-SiO₂/X-PS of Example 2 (1 g) and trimethylamine (25 wt. % in water, 20 mL) was stirred for 24 hours at room temperature. The obtained solid was then washed with water until neutral pH and then mixed with NaOH (2%, 20 mL) and stirred for 12 hours. After centrifuging and washing with H₂O until neutral pH, K₃[Fe(CN)₆] (1 g) was added and the mixture was stirred for 24 hours. The reaction mixture was then centrifuged and washed with H₂O until neutral pH. A yellow powder was collected and dried at 60° C. under vacuum overnight.

### Example 5

### Synthesis of m-SiO₂/CNT

m-SiO₂/X—PS-Fe (0.5 g) was loaded into tubular furnace and heated from room temperature to 310° C. at 2° C./min and then to 370° C. at 1° C./min, held for 2 hours, then heated to 800° C. at 10° C./min, and held for 4 h under argon (100 cc/min). After cooling to room temperature, 0.31 g of black powder was obtained.

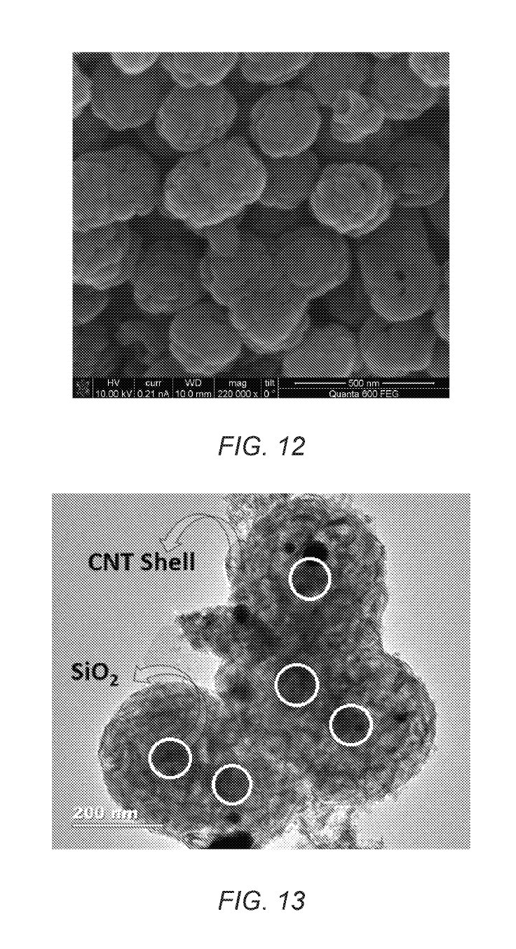

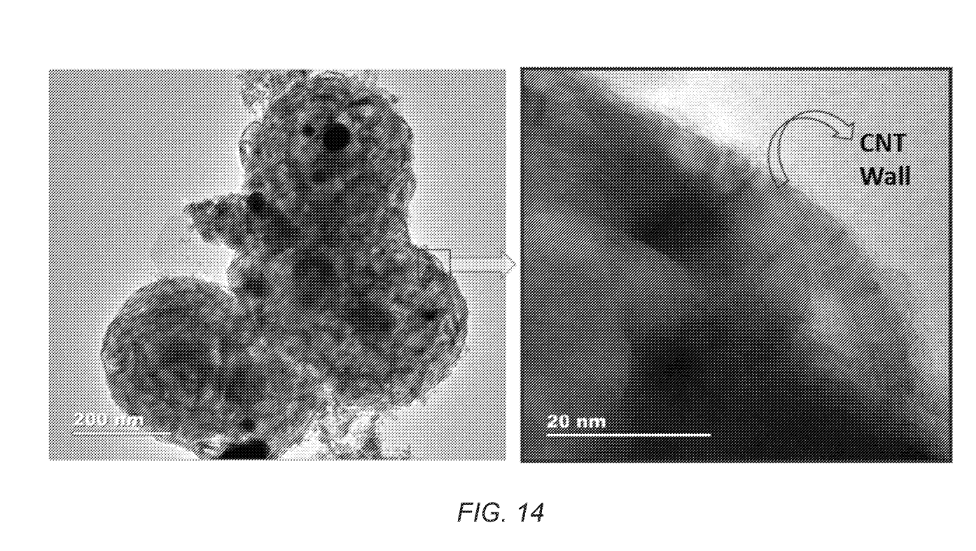

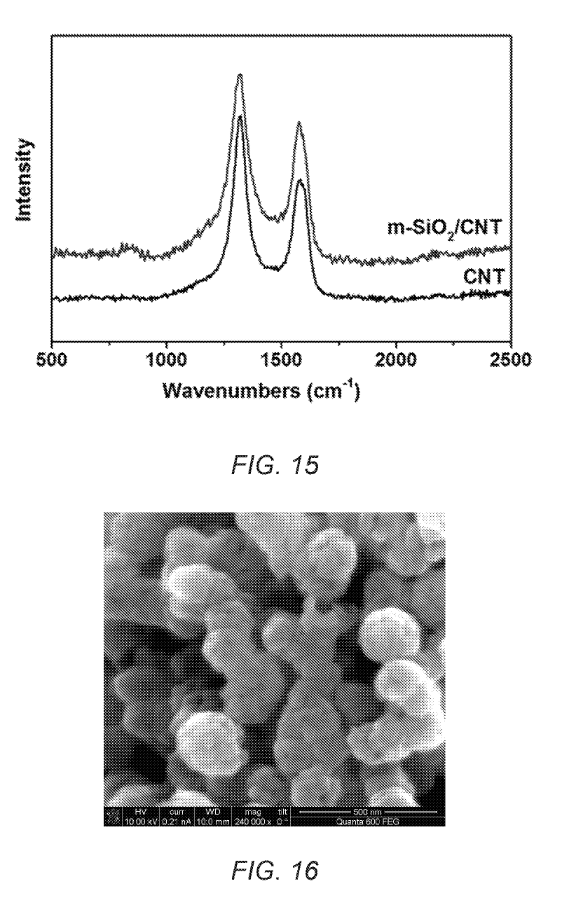

FIG. 12 shows the SEM image of m-SiO₂/CNT multi-core/shell particles. A shell composed of short tubes was observed. FIG. 13 is the TEM image of m-SiO₂/CNT multi-core/shell particles. Silica cores were encapsulated by the CNT shell. The high-magnification TEM image of m-SiO₂/CNT (FIG. 14) shows the CNT wall more clearly. FIG. 15 is the Raman spectra for synthesized m-SiO₂/CNT, which matched commercial CNT as received.

### Example 6

### (Synthesis of CNT Hollow Spheres (CNT-HP))

SiO₂/CNT (0.2 g) was refluxed in concentrated HNO₃ (20 mL) overnight. After washing with water until neutral pH, the black solid was mixed with 10% HF (20 mL) and stirred for 12 hours. After centrifuging and washing with water until neutral pH, the black powder was collected and dried at 60° C. under vacuum overnight.

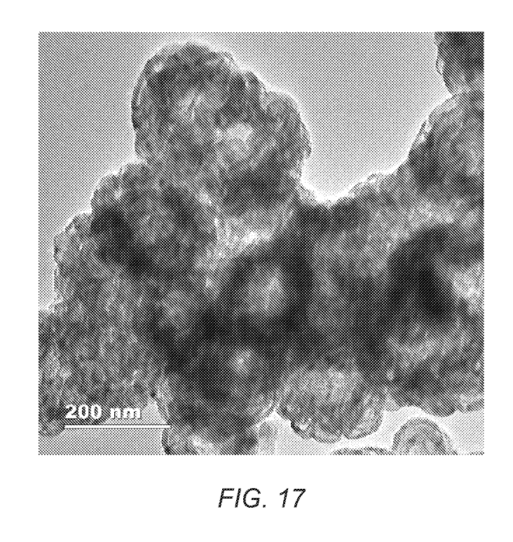

FIG. 16 shows the SEM image of CNT hollow spheres. From the SEM, it was determined that the CNT spheres were not damaged by treatment with HNO₃ and HF. FIG. 17 shows the TEM image of CNT hollow spheres. Silica cores disappeared after treatment with HF.

1. A carbon nanotube material comprising a shell having a network of carbon nanotubes and a plurality of discrete void spaces contained within and surrounded by the network, wherein the boundary of each void space is defined by the carbon nanotube network.

2. The carbon nanotube material of claim 1, wherein the average volume of each discrete void space is 1 nm³ to 106 μm³.

3. The carbon nanotube material of claim 1, wherein the shell consists essentially of or consists of carbon nanotubes.

4. The carbon nanotube material of claim 1, comprising 2 to 10,000 void spaces.

5. The carbon nanotube material of claim 1, wherein the shell has a flow flux of 1×10−6 to 1×10−4 mol m−2s−1 Pa.

6. The carbon nanotube material of claim 1, wherein each void space comprises a nanostructure.

7. The carbon nanotube material of claim 6, wherein the nanostructure comprises a metal nanoparticle, a metal oxide nanoparticle, a silicon particle, a carbon-based nanoparticle, a metal organic framework nanoparticle, a zeolitic imidazolated framework nanoparticle, a covalent organic framework nanoparticle, or any combination thereof.

8. The carbon nanotube material of claim 7, wherein the metal nanoparticle is a noble metal selected from the group consisting of silver (Ag), palladium (Pd), platinum (Pt), gold (Au), rhodium (Rh), ruthenium (Ru), rhenium (Re), or iridium (Ir), or any combinations or alloys thereof.

9. The carbon nanotube material of claim 7, wherein the metal nanoparticle is a transition metal selected from the group consisting of copper (Cu), iron (Fe), nickel (Ni), zinc (Zn), manganese (Mn), chromium (Cr), molybdenum (Mo), tungsten (W), osmium (Os), or tin (Sn), or any combinations or oxides or alloys thereof.

10. The carbon nanotube material of claim 7, wherein the carbon-based nanoparticle comprises carbon nanotubes.

11. The carbon nanotube material of claim 6, wherein each nanostructure has a diameter of 1 nm to 1000 nm, preferably 1 nm to 50 nm, or more preferably 1 nm to 5 nm.

12. The carbon nanotube material of claim 6, wherein each nanostructure fills 1% to 99%, preferably 30% to 60%, of the volume of each void space, or each nanostructure fills the entire volume of each void space.

13. The carbon nanotube material of claim 1, wherein the shell or carbon nanotube network further comprises a polymer, a metal particle, a metal oxide particle, a silicon particle, a carbon-based particle, a metal organic framework particle, a zeolitic organic framework particle, a covalent organic framework particle, or any combination thereof.

14. The carbon nanotube material of claim 1, wherein the carbon nanotubes in the network are single walled carbon nanotubes, multi-walled carbon nanotubes, or both.

15. The carbon nanotube material of claim 1, wherein the shell is a monolith network of carbon nanotubes.

16. A method of making a multi-core/carbon nanotube shell material, the method comprising:
(a) obtaining a composition comprising a plurality of nanostructures dispersed throughout a carbon-containing polymeric matrix; and
(b) subjecting the carbon-containing polymeric matrix to a graphitization process to form a shell having a carbon nanotube network from the matrix; and
(c) partially or fully etching away the plurality of nanostructures such that a plurality of discrete void spaces are obtained, wherein the boundary of each discrete void space is defined by the carbon nanotube network,
wherein the multi-core/carbon nanotube shell material is obtained that includes a shell having a network of carbon nanotubes and a plurality of discrete nanostructure cores contained within and surrounded by the network.

17. A multi-core/carbon nanotube shell material made by the process of claim 16.

18. A method for using the carbon nanotube material of claim 1 in a chemical reaction, the method comprising contacting the material with a reactant feed to catalyze the reaction and produce a product feed.

19. The carbon nanotube material of claim 1, wherein the carbon nanotube or multi-core/carbon nanotube is comprised in an energy storage device, preferably a battery, a controlled released device, a fuel cell, or a supercapacitor.

20. An energy device comprising the carbon nanotube material of claim 1.
